(19) United States
(12) Patent Application Publication
(10) Pub. No.: US 2016/0093451 A1
(43) Pub. Date: Mar. 31, 2016

(54) LIGHTED CIRCUIT BREAKER STATUS INDICATION DEVICE

(71) Applicant: Mechanical Products Company, Lombard, IL (US)

(72) Inventors: Brian Lamerdin, Glenview, IL (US); Cuong Ha, Lincolnwood, IL (US); Robert Holmes, Summit Township, MI (US); Ronald Prokup, Lake Barrington, IL (US)

(21) Appl. No.: 14/863,040

(22) Filed: Sep. 23, 2015

Related U.S. Application Data
(60) Provisional application No. 62/056,160, filed on Sep. 26, 2014.

(51) Int. Cl. H01H 13/02

(52) U.S. Cl. CPC H01H 13/023; H01H 2219/036; H01H 2219/0621

(57) ABSTRACT

A lighted circuit breaker status indication device includes a light guide made of one of transparent and translucent material. At least one light source is configured to illuminate the light guide. The light source is coupled to a circuit breaker by at least one electrical contact. A status circuit path of the light circuit breaker status indication device is coupled to the circuit breaker and configured to provide power to the light source when the circuit breaker is both energized and open, and not to provide power to the light source when the circuit breaker is one of not energized and closed.

### CROSS REFERENCE TO RELATED APPLICATIONS

The present application claims the benefit of Lamerdin et al., U.S. provisional patent application Ser. No. 62/056,160, filed on Sep. 26, 2014, and entitled “Lighted Circuit Breaker Status Indication Device”. The entire contents of this application are incorporated herein by reference.

### REFERENCE REGARDING FEDERALLY SPONSORED RESEARCH OR DEVELOPMENT

Not applicable

### SEQUENTIAL LISTING

Not applicable

### FIELD OF THE DISCLOSURE

The present subject matter relates to electrical circuit protection devices, and more particularly to circuit breaker status indication devices.

### BACKGROUND

The status of a circuit breaker, (e.g. on or off), cannot always be easily determined from the position of an actuator, handle or button. This is particularly true under low ambient light levels, or when the observer is some distance away from the breaker, or when the observer is inexperienced at using circuit breakers. It is important to know the status of a given circuit breaker to help determine whether an electrical overload has occurred in a given circuit or whether the circuit breaker is in the open (off) or closed (on) position.

Lighted circuit breaker status indication devices may be built into the physical circuit breaker during manufacture. However, these devices require the circuit breaker to be purchased either with or without the lighted option.

In other examples, lighted circuit breaker status indication devices may attach to the circuit breaker as an add-on feature, such that the device is not part of the physical circuit breaker. However, these add-on devices typically require connection to the same circuit breaker terminals as those used to connect the circuit in the application to be protected. Positioning such devices in the areas of the circuit breaker terminals can interfere with normal terminal connection. Attaching multiple wire terminal lugs on circuit breaker terminals creates inherent installation, conductivity, reliability and positioning issues, making it more difficult to properly connect the normal “line” and “load” or “auxiliary” and “battery” wires of the application circuit.

Lighted circuit breaker status indication devices which may attach to the circuit breaker as an add-on feature, but do not require physical connection to the main circuit breaker terminal areas, require either additional connections to a second circuit (to power the light) or stored energy devices, like batteries or capacitors, to power the lighted indicator. The additional connections and secondary circuits can be expensive, cumbersome, or even unavailable in many applications. Stored energy devices are often also expensive. Additionally, stored energy devices are generally useful only as long as they maintain enough energy to power the light.

Accordingly, there remains a need for a lighted indicator system which will better show to a remote observer the on/off state of a circuit breaker, and which can be added onto a circuit breaker which may have already been installed in a field application, and which will not connect to the existing circuit breaker terminations nor require stored energy devices.

### SUMMARY

According to one aspect, a lighted circuit breaker status indication device includes a light guide made of one of transparent and translucent material, at least one light source configured to illuminate the light guide, and at least one electrical contact electrically coupling the light source to a circuit breaker. The lighted circuit breaker status indication device further includes a status circuit path coupled to the circuit breaker. The status circuit path is configured to provide power to the light source when the circuit breaker is both energized and open, but not to provide power to the light source when the circuit breaker is one of not energized and closed.

According to another aspect, a system for providing visual indication of an on/off status of a circuit breaker includes a light guide and a status circuit path configured to be coupled to a protected circuit path of the circuit breaker. The status circuit path is further configured to provide power to a light source when the protected circuit path is both energized and open, but not to provide power to the light source when the protected circuit path is one of not energized and closed. Additionally, when power is provided to the light source, the light source illuminates the light guide.

### BRIEF DESCRIPTION OF THE DRAWINGS

FIG. 1 is an isometric view of a light guide portion of a lighted circuit breaker status indication device;

FIG. 2 is an isometric view of a circuit board of a lighted circuit breaker status indication device;

FIG. 3 is an isometric view of an alternative embodiment of the circuit board of a FIG. 2;

FIG. 4 is a schematic of the circuit in an alternative embodiment of the circuit board of FIG. 2;

FIG. 5 is an isometric view of a lighted circuit breaker status indication device with the light guide and circuit board portions of FIGS. 1 and 2, respectively, assembled;

FIG. 6 is an isometric view of the lighted circuit breaker status indication device of FIG. 5 further assembled with a gasket;

FIG. 7 is an isometric view of the gasket shown in the assembled lighted circuit breaker status indication device of FIG. 6;

FIG. 8 is a side view of the lighted circuit breaker status indication device of FIG. 5;

FIG. 9 is a bottom view of a circuit breaker;

FIG. 10 is a bottom view of a circuit breaker with the lighted circuit breaker status indication device of FIG. 5 positioned thereon;

FIG. 11 is a top view of the circuit breaker of FIG. 9; and

FIG. 12 is an isometric view of an alternate circuit breaker with the lighted circuit breaker status indication device positioned thereon.

### DETAILED DESCRIPTION

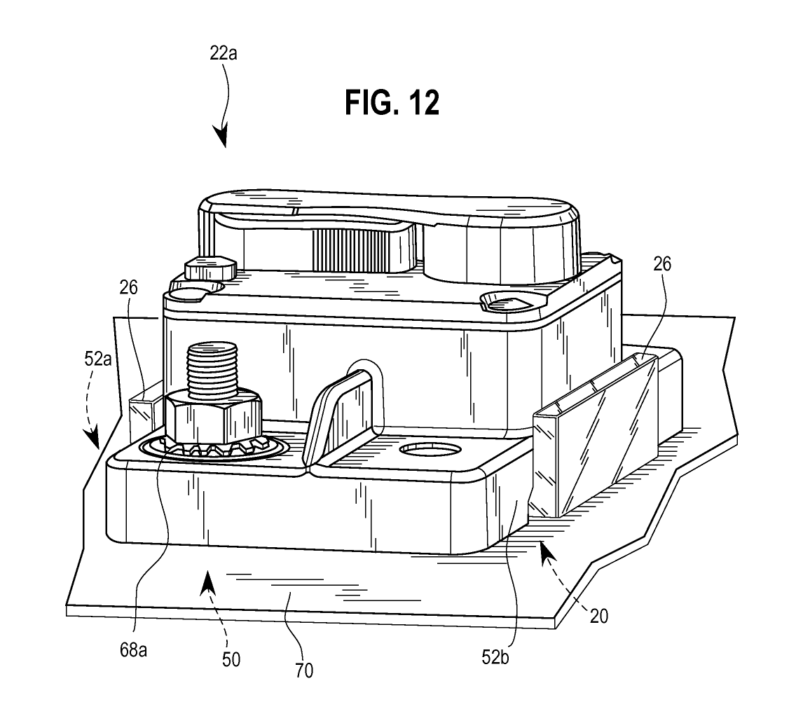

A lighted circuit breaker status indication device 20 is provided. The lighted circuit breaker status indication device 20 is configured to be attached in retrofit fashion to an existing circuit breaker 22. The lighted circuit breaker status indication device 20 may be powered by an existing circuit to be protected while not interfering with the circuit breaker terminations 68a, 68b (shown in FIGS. 11 and 12).

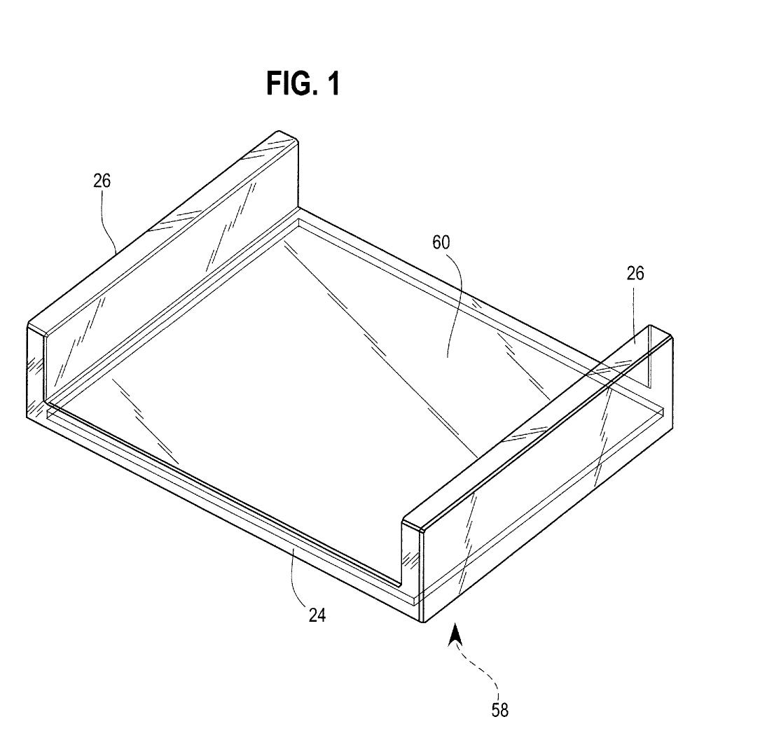

Referring now to FIG. 1, a light guide 24 portion of the lighted circuit breaker status indication device 20 is shown. The light guide 24 may be made of transparent or translucent plastic material. In this example, the light guide 24 has a pair of upright legs 26. Light guides, generally, transport light from a light source to another location such as an output surface of a light guide. For example, light may be transmitted through the light guide 24 by total internal reflection.

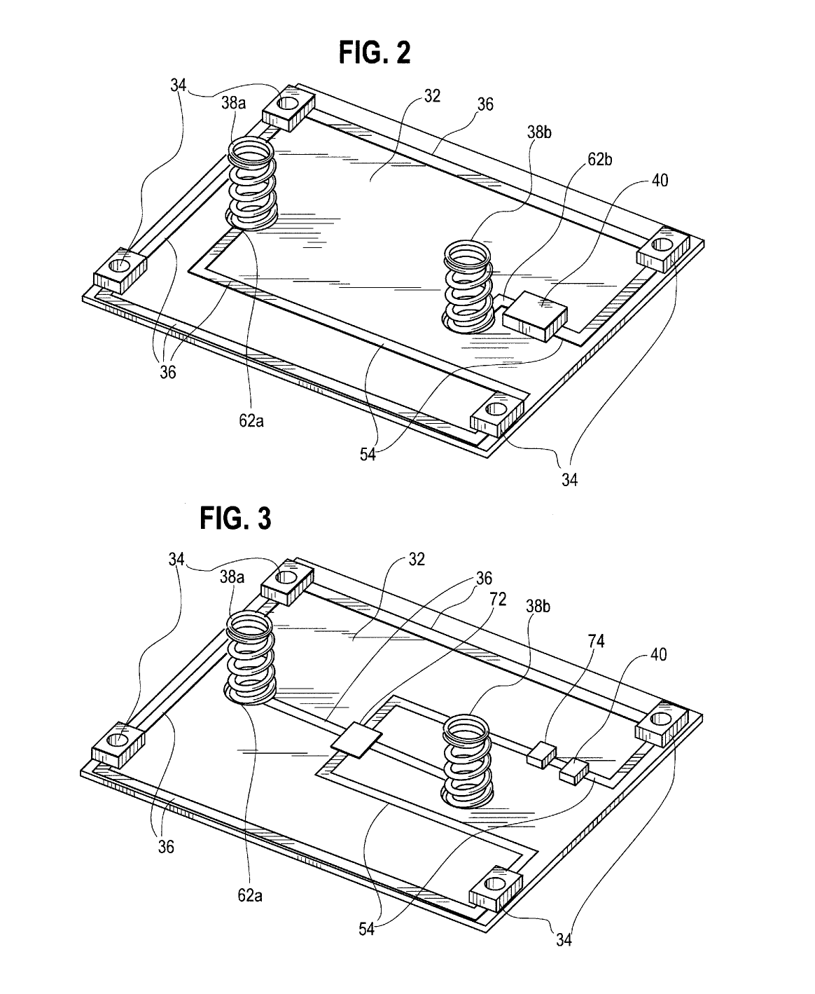

Referring now to FIG. 2, a circuit board 32 portion of the lighted circuit breaker status indication device 20 is shown. In this example embodiment, the circuit board 32 has at least one incandescent, neon, or light emitting diode (LED) light source(s) 34, connected by circuit board traces 36, to springs 38a, 38b. Other types of light source(s) 34 may alternatively be employed for providing illumination of the light guide 24 when the lighted circuit breaker status indication device 20 is assembled. In this example, the light source(s) 34 are connected to springs 38a, 38b through resistor 40 via circuit board traces 36. The springs act as connection pieces that connect electrical contact points 62a, 62b of the status indication device 20 with electrical contact mating points 46a, 46b on the circuit breaker 22.

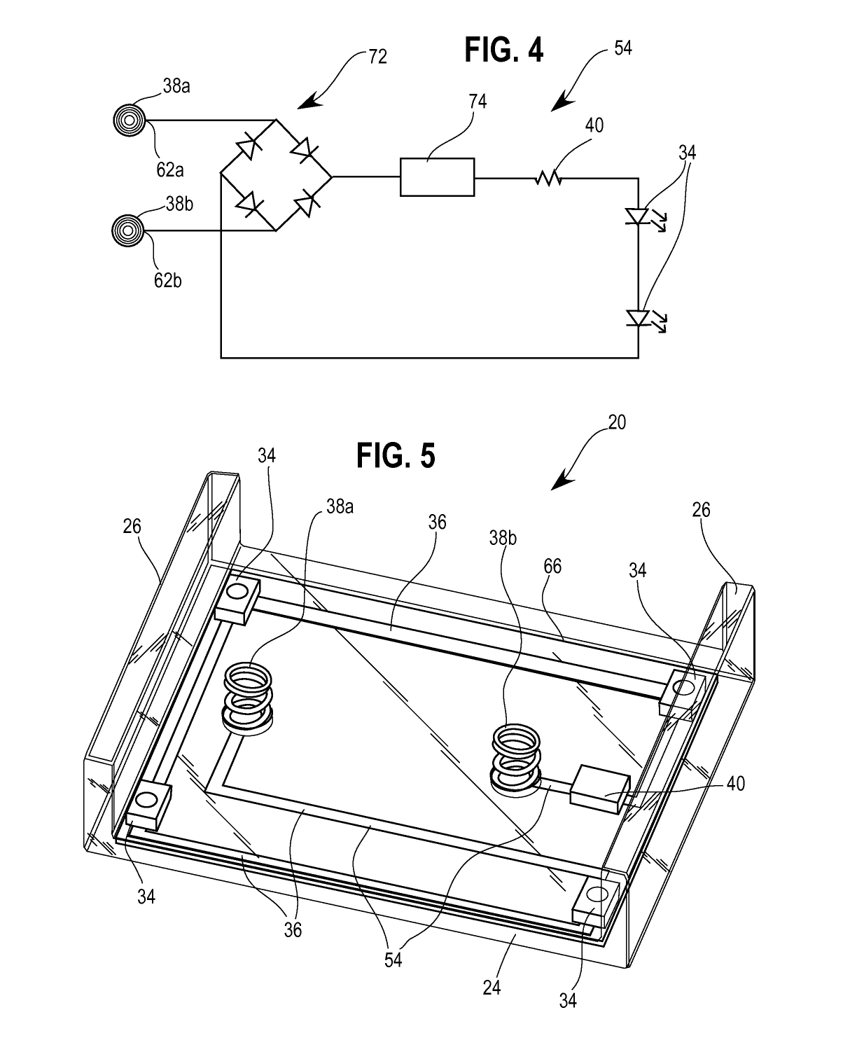

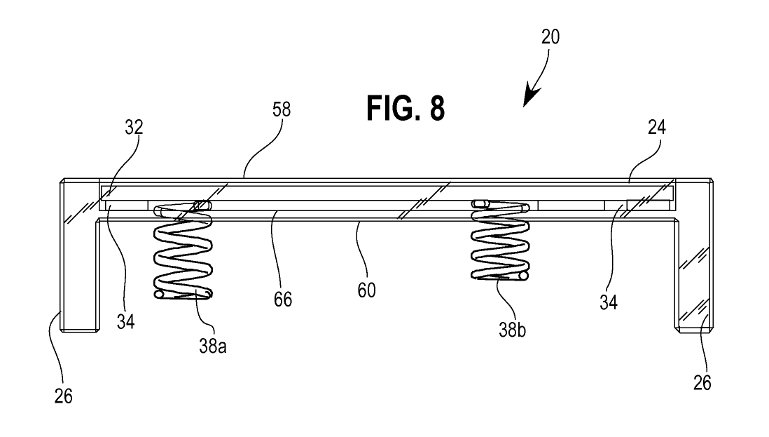

FIGS. 5 and 8 show lighted circuit breaker status indication device 20 with the light guide 24 and circuit board 32 portions assembled. In particular, the upright legs 26 of the light guide 24 are shown with the springs 38a, 38b in FIG. 8.

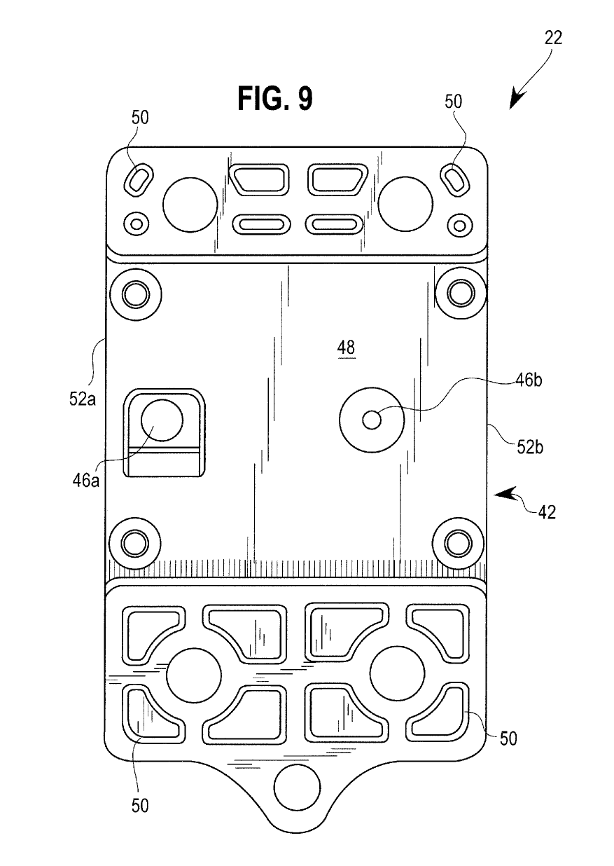

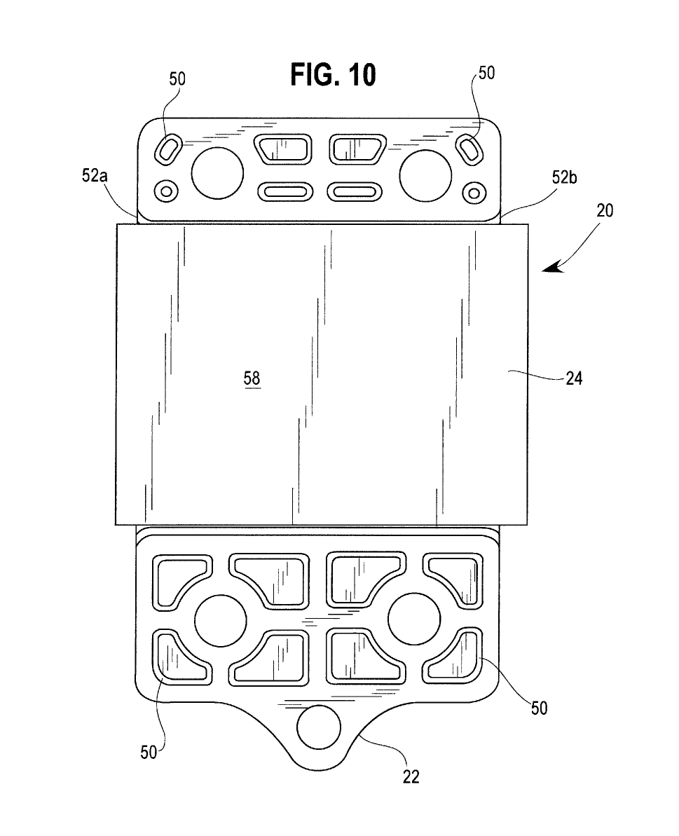

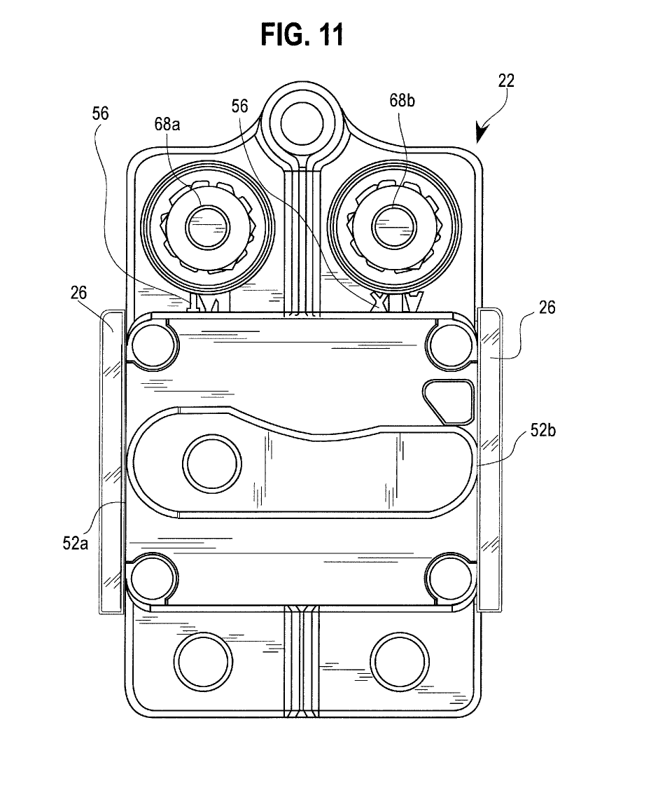

FIG. 9 shows the bottom portion 42 of an example circuit breaker 22. As seen, the bottom portion 42 of the circuit breaker 22, in this example, includes electrical contact mating points 46a, 46b on a recessed bottom surface 48 between two mounting legs 50. Alternative circuit breaker arrangements may be selectively employed. FIG. 10 shows the lighted circuit breaker indication device 20 installed at the bottom of circuit breaker 22.

FIGS. 11 and 12 respectively, show a top view of the circuit breaker 22 and an isometric view of an alternate circuit breaker 22a with the lighted circuit breaker indication device 20 installed thereon. In particular, the upright legs 26 of light guide 24 are shown wrapping around the sides 52a, 52b of the circuit breaker 22, 22a. The lighted circuit breaker status indication device 20 may be installed on circuit breakers of more than one style and configuration without modification. Further, modification may be made to the location, size, and shape of the springs 38a, 38b, the legs 26a, 26b, the light guide 24, the gasket 64, and a number of other features so that the device 20 may align with and be installed on various styles of circuit breakers; for example the circuit breakers shown in FIGS. 11 and 12 (22, 22a).

As seen in FIGS. 9, 10, 11, and 12, the lighted circuit breaker indication device 20, in this example, is installed under the bottom portion 42 of the circuit breaker 22 between the circuit breaker mounting legs 50 with the upright legs 26 of the light guide 24 directed toward the top of the circuit breaker 22. The lighted circuit breaker indication device 20 is held in place between the recessed bottom surface 48 of the circuit breaker 22 and the panel surface 70 on which the circuit breaker 22 is mounted. The force of the springs 38a, 38b of circuit board 32 pressing against the electrical contact mating points 46a, 46b on the circuit breaker 22 further hold the lighted circuit breaker status indication device 20 in place with the circuit breaker 22. In alternative embodiments, the connection pieces formed by the springs 38a, 38b may be clips, blades, or another suitable mechanical connection piece for connecting the electrical contacts 62a, 62b of the status circuit path 54 to the electrical contact mating points 46a, 46b of the circuit breaker 22. In further alternative embodiments, the springs 38a, 38b may be positioned on the light guide 24 and connected to the circuit board 32 via wiring or another electrical connection. Further, the lengths and relative positioning of the springs 38a, 38b may assure correct alignment of the lighted circuit breaker status indication device 20. The springs 38a, 38b may be of different lengths such that they only make contact with the electrical contact mating points 46a, 46b of the circuit breaker 22 when the device 20 is oriented correctly. Further still the positions of the springs 38a, 38b may be offset from the center of the light guide 24 such that the springs 38a, 38b may only make contact with the electrical contact mating points 46a, 46b when the device 20 is aligned correctly

As installed on circuit breaker 22, the status circuit path 54 of the lighted circuit breaker status indication device 20 is from one electrical contact mating point 46a through spring 38a, the traces 36, the light source(s) 34, the resistor 40, and back through a spring 38b to the other electrical contact mating point 46b. The resistor 40 may vary in ohmic value depending on the application of the circuit breaker. In one example embodiment, the ohmic value of the resistor 40 is 330 ohms. This status circuit path 54 of the lighted circuit breaker indication device 20 constitutes a parallel electrical circuit path to the (internal) protected circuit path 56 of the circuit breaker 22 and the voltage drop between points 46a and 46b within the protected circuit path 56 provides the power to illuminate the light source(s) 34 when appropriate voltage is applied to the circuit path 56 and the circuit breaker 22 is in the open (off) position.

In another example embodiment shown in FIG. 3, the status circuit path 54 of the lighted circuit breaker status indication device 20 is from one electrical contact mating point 46a through spring 38a, the traces 36, a bridge rectifier 72, a voltage regulator 74, the resistor 40, the light source(s) 34, and back through a spring 38b to the other electrical contact mating point 46b. Again, this example embodiment of status circuit path 54 of the lighted circuit breaker indication device 20 constitutes a parallel electrical circuit path to the protected circuit path 56 of the circuit breaker 22 and provides power to illuminate the light source(s) 34 when activated. FIG. 4 further illustrates a schematic of an example embodiment of the status circuit path 54 shown and described with respect to FIGS. 2 and 3. The example in the schematic of FIG. 4 shows only two LEDs as light source(s) 34. Alternative embodiments include different numbers of individual light source(s) 34 such as the two LEDs of the schematic in FIG. 4 or the four LEDs depicted in FIGS. 2 and 3. The schematic of FIG. 4 further depicts the configuration of the bridge rectifier 72, voltage regulator 74, resistor 40, and electrical contact points 62a, 62b.

In this example embodiment, with the circuit breaker 22 in the closed (on) position and installed in an application with appropriate voltage applied to the circuit path 56 being protected, the voltage drop across the circuit breaker 22 will be insufficient to allow enough current to flow through the status circuit path 54 to illuminate the light source(s) 34 of the status indication device 20. If the circuit breaker 22 switches to the open (off) position, either due to an electrical overload, being manually switched, or through some other means, with appropriate voltage still applied to the circuit path 56 of the circuit breaker 22, the voltage drop across the circuit breaker 22 will allow sufficient current through the status circuit path 54 of the lighted circuit breaker status indication device 20 to illuminate the light source(s) 34. The illumination from the light source(s) 34 is transmitted through and illuminates the light guide 24 (including upright legs 26 of light guide 24) thereby assisting an observer in determining whether an electrical overload has occurred in a given circuit to be protected and that the circuit breaker 22 is in the open (off) position. When the light source(s) 34 illuminate the light guide 24, the illumination of the light guide 24 signifies to an observer that the circuit breaker is both energized and open (off). However, the absence of illumination may signify to an observer that the circuit breaker 22 is not energized, the circuit breaker is closed (on) and energized, or that the circuit breaker is open (off) but not energized.

In an example embodiment, when the light source(s) 34 are powered by the status circuit path 54 the entire body of the light guide 24 may be visibly illuminated, including the legs 26 and the top 58 and bottom 60 surfaces of the light guide 24. The bottom surface 60 of the light guide is disposed between the legs 26. Alternatively, the light guide 24 may be configured to provide a number of illumination patterns. In another embodiment, only the top surface 58 of the light guide 24 may be visibly illuminated. In still another example embodiment, selected surfaces of the light guide 24 and legs 26 may be visibly illuminated.

The upright legs 26 of light guide 24 are positioned so as to be close to or touching the sides 52a, 52b of the circuit breaker 22 when installed, as seen in FIGS. 10, 11 and 12. The width of the assembly of the light guide 24 and the circuit board 32 of the lighted circuit breaker status indication device 20, in this example, is less than the space available on the recessed bottom surface 48 between the mounting legs 50 of the circuit breaker 22. The thickness of the general circuit board 32 area of the lighted circuit breaker status indication device 20 is less than the space between the recessed bottom surface 48 of the circuit breaker 22 and the panel surface 70 on which the circuit breaker 22 is mounted.

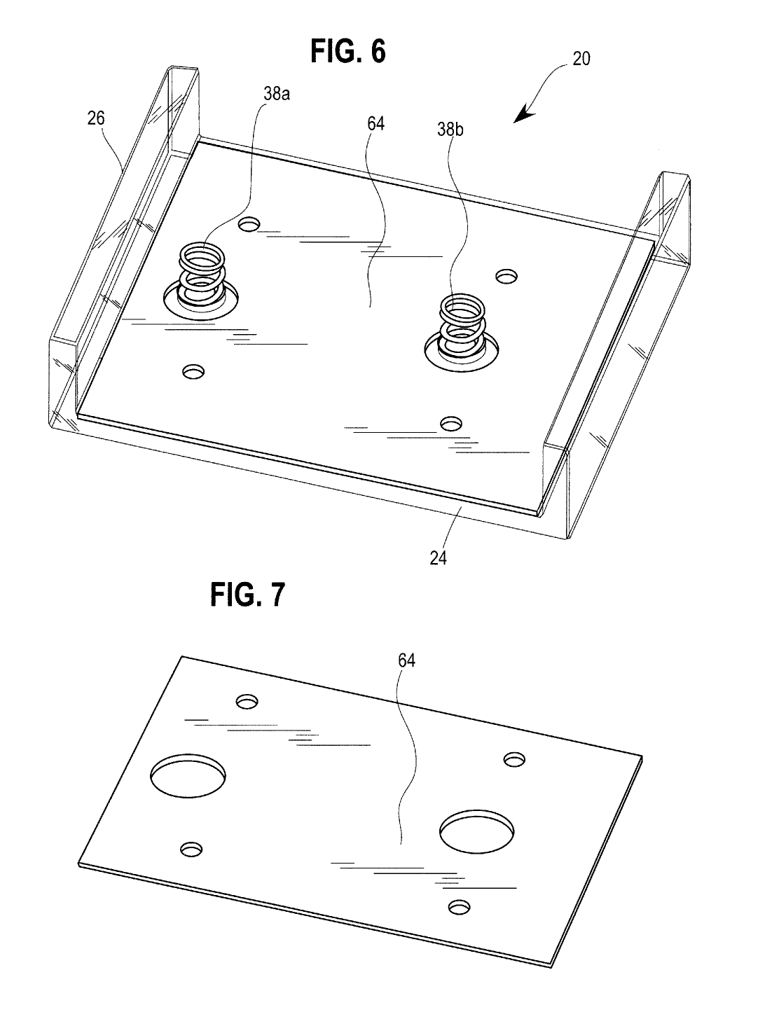

In an alternative embodiment shown in FIG. 6, a gasket 64 may be positioned on the light guide 24. The bottom surface of the light guide 60 may combine with the gasket 64 to form a recess 66. The circuit board 32 and other electrical components, such as resistors or other active or passive electrical components such as the bridge rectifier 72 and voltage regulator 74, may be housed within the recess 66. The gasket 64 may then be closed by the recessed bottom surface 48 of the circuit breaker 22 or another suitable surface of the circuit breaker 22. The gasket 64 may act to protect the circuit board 32 and electrical components from the outside environment. The gasket 64 may be made of rubber, plastic, metal, or another suitable material. In a further alternative embodiment, the light guide 24 may have a ridge or indentation to align and position the gasket 64 such that the gasket 64 fits into the light guide 24. One embodiment of the gasket 64 before it is positioned on the light guide 24 is depicted in FIG. 7.

The status indication device 20 as shown in FIG. 5 is constructed such that the light guide 24 portion may be made of any sufficiently transparent material. For example, the light guide 24 portion may be formed of transparent or translucent plastic such as Lexan, polycarbonate, acrylic, ABS, or other suitable transparent or translucent material. The circuit board 32 portion of the status indication device 20 may be made of any sufficiently insulating material capable of retaining one or more light source(s) 34 in position next to the light guide 24, for example G10 fiberglass, or Kapton. The traces 36, resistor 40, and the springs 38a, 38b may or may not be attached to the circuit board 32. The springs 38a, 38b may alternatively be connected to the circuit breaker 22 in places other than the contact mating points 46a, 46b. The light source(s) 34 may be connected in either a series or parallel configuration, or some combination of the two. The circuit board 32 of the status indication device 20 and the light source(s) 34 may be mounted on the top 58 or bottom 60 surfaces of the light guide 24, or recessed or embedded within the light guide 24. Alternatively, the light source(s) 34 may be mounted on the circuit board 32 and operatively coupled to the light guide 24, such as by aligning the light source(s) 34 with a portion of the light guide 24.

The lighted circuit breaker status indication device 20 provides for the ability to easily determine the on or off status of a circuit breaker 22, regardless of ambient light levels, viewing angle, or visibility of an actuator, handle or button. In addition, the status indication device 20 is able to be installed as a retrofit device onto an existing circuit breaker 22 already in use in an application. This may provide for flexibility in both purchase and use of a circuit breaker 22, as the determination of whether lighted status indication is necessary can be made at a time after the initial purchase or installation of a circuit breaker 22. Use of existing circuit voltage to power the lighted circuit breaker status indication device 20 negates many reliability issues inherent in stored energy devices.

The status indication device 20 provided herein allows for automatic connection to a circuit breaker 22 by use of springs 38a, 38b during installation at locations other than the main circuit breaker 22 terminals. Installation of the status indication device 20 away from the circuit breaker 22 terminals may reduce hazard, reliability, or interference issues with the main circuit connections. Since there is only one mounting configuration that allows mating of the springs 38a, 38b of the status indication device 20 to the circuit breaker 22, this assures the status indication device 20 will contact the correct electrical contact mating points 46a and 46b of the circuit breaker 22.

As seen, a lighted circuit breaker status indication device 20 is provided. The status indication device 20 is configured to be attached to an existing circuit breaker 22 and powered by an existing circuit path 56 of the circuit breaker 22. The status indication device 20 has a light guide 24 transmitting light along the sides 52a, 52b of the circuit breaker 22 from light source(s) 34 in the status circuit path 54 parallel with the circuit breaker 22. The status indication device 20 is configured to make use of the empty space between the circuit breaker 22 and a mounting panel surface 70. The status indication device 20, in this example embodiment, makes electrical contact at the bottom 42 of the circuit breaker 22 to avoid interference with existing circuit breaker 22 terminals. The light source(s) 34, providing illumination of light guide 24, may be positioned underneath circuit breaker 22 as an indicator of the on/off status of the circuit breaker. Illuminated light is made visible from the front of the circuit breaker 22 by the front surface 58 of light guide 24. The light guide 24 further has upright legs 26 that extend around the circuit breaker 22 and abut sides 52a, 52b of the circuit breaker 22.

The light source(s) 34 are coupled with electrical contact mating points 46a, 46b on the underside of the circuit breaker terminals 68a, 68b via springs 38a, 38b and traces 36 to electrical contact points 62a, 62b of the status circuit path 54 that provides power to said light source(s) 34. The lighted circuit breaker status indication device 20 is configured to be positioned under a circuit breaker 22 during installation, such that it may be utilized as an aftermarket type of add-on device. In this example embodiment, light source(s) 34 may be illuminated when the circuit breaker 22 is open (i.e. tripped position, not conducting current). The light source(s) 34 are not illuminated when the circuit breaker is closed (i.e. latched position, and conducting current). As such, the status indication device 20 allows an observer to easily assess the on/off status of the circuit breaker 22 without the device 20 interfering with existing circuit breaker terminals.

The embodiment(s) detailed above may be combined in full or in part, with any alternative embodiment(s) described.

### INDUSTRIAL APPLICABILITY

It is important to know the status of a given circuit breaker to help determine whether an electrical overload has occurred in a given circuit or whether the circuit breaker is in the open (off) or closed (on) position. Accordingly, the status indication device contemplated above may provide a lighted indicator system that will better show to a remote observer the on/off state of a circuit breaker. Further, the status indication device contemplated above may address the need for a device that can be added onto a circuit breaker after the circuit breaker has already been installed in a field application. Further still, the status indication device contemplated above may neither require connection to the existing circuit breaker terminations nor require stored energy devices to provide power to the add-on feature.

The status indication device may provide further advantages such as ease of installation. The non-symmetrical positioning of the springs, which allows the status indication device to make electrical contact with the circuit breaker, contemplated in some embodiments allows for the alignment of the light guide, light guide legs, and electrical connections during installation of the device. The status indication device may be shaped in such a way to provide a customized fit to an existing circuit breaker. Alternatively, the status indication device may be provided with a generic shape that easily fits one or more styles and shapes of circuit breakers.

The use of the terms “a” and “an” and “the” and similar references in the context of describing the disclosure (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

Numerous modifications to the present disclosure will be apparent to those skilled in the art in view of the foregoing description. Preferred embodiments of this disclosure are described herein, including the best mode known to the inventors for carrying out the disclosure. It should be understood that the illustrated embodiments are exemplary only, and should not be taken as limiting the scope of the disclosure.

We claim:

1. A lighted circuit breaker status indication device comprising:
a light guide made of one of transparent and translucent material;
at least one light source configured to illuminate the light guide;
at least one electrical contact to provide electrical coupling of the light source to a circuit breaker; and
a status circuit path coupled to the circuit breaker, the status circuit path configured to provide power to the light source when the circuit breaker is both energized and open, and the status circuit path configured not to provide power to the light source when the circuit breaker is one of not energized and closed.

2. The lighted circuit breaker status indication device of claim 1, wherein the light guide has a plurality of legs, the legs abutting at least two sides of the circuit breaker when the light guide is installed at the circuit breaker.

3. The lighted circuit breaker status indication device of claim 2, wherein when the status circuit path provides power to the light source, an entire body of the light guide is visibly illuminated.

4. The lighted circuit breaker status indication device of claim 2, wherein when the status circuit path provides power to the light source, a front surface of the light guide is visibly illuminated and the legs abutting the at least two sides of the circuit breaker are visibly illuminated.

5. The lighted circuit breaker status indication device of claim 1, wherein the light source is one of an incandescent light source, a neon light source, and a light emitting diode.

6. The lighted circuit breaker status indication device of claim 1, wherein the at least one electrical contact includes two electrical contacts respectively positioned at end points of the status circuit path, and further comprising:
a circuit board, the circuit board including the status circuit path; and
wherein the light source is mounted on the circuit board.

7. The lighted circuit breaker status indication device of claim 6, wherein when the light guide is installed at the circuit breaker, the two electrical contact points are respectively coupled to mating points of a circuit path of the circuit breaker such that the status circuit path is in parallel to the circuit path of the circuit breaker.

8. The lighted circuit breaker status indication device of claim 6, further comprising:
at least one resistor on the circuit board, and the status circuit path including the at least one resistor.

9. The lighted circuit breaker status indication device of claim 8, further comprising:
at least one bridge rectifier on the circuit board, and
at least one voltage regulator on the circuit board, and wherein the status circuit path includes the at least one bridge rectifier and voltage regulator.

10. The lighted circuit breaker status indication device of claim 7, further comprising:
at least one connection piece configured to connect the two electrical contact points to the mating points of the circuit path of the circuit breaker when the light guide is installed at the circuit breaker.

11. The lighted circuit breaker status indication device of claim 10, wherein the at least one connection piece further comprises a pair of springs, each spring coupled to a respective one of the electrical contact points and configured to connect with a respective one of the mating points of the circuit breaker.

12. The lighted circuit breaker status indication device of claim 6, wherein the two electrical contact points are respectively coupled to the mating points of the circuit path of the circuit breaker after the circuit breaker is in use.

13. The lighted circuit breaker status indication device of claim 1, wherein the light guide is installed at the circuit breaker after the circuit breaker is in use.

14. A system for providing visual indication of an on/off status of a circuit breaker comprising:
a light guide;
a status circuit path configured to be coupled to a protected circuit path of the circuit breaker;
wherein the status circuit path is configured to provide power to a light source when the protected circuit path is both energized and open, and the status circuit path is configured not to provide power to the light source when the protected circuit path is one of not energized and closed; and
wherein when power is provided to the light source, the light source illuminates the light guide.

15. The system of claim 14, wherein the light guide is made of one of translucent and transparent material and the light guide further comprises:
a plurality of legs; and
a first surface disposed between the plurality of legs, the first surface configured to align with a center of the circuit breaker and the plurality of legs configured to abut at least one side of the circuit breaker.

16. The system of claim 15, wherein the plurality of legs and the first surface are illuminated when the light source illuminates the light guide.

17. The system of claim 14, wherein the status circuit path is coupled by a plurality of electrical contacts to a plurality of corresponding mating points of the protected circuit path after the circuit breaker has been installed.

18. The system of claim 17, wherein the status circuit path is coupled by the plurality of electrical contacts to the plurality of corresponding mating points of the protected circuit path by a plurality of springs, the springs having relative lengths corresponding to locations of the mating points.

19. The system of claim 18, wherein the springs are offset from the center of the light guide such that the plurality of electrical contacts are coupled to the plurality of corresponding mating points only when the light guide is correctly aligned with the circuit breaker.

20. The system of claim 14, further comprising:
a circuit board having mounted thereon the light source, the status circuit path, a plurality of electrical contacts, and at least one passive electrical component;
wherein the passive electrical component is part of the status circuit path, and the circuit board is mounted to the light guide; and
a gasket fixed to the light guide;
wherein the light guide and the gasket form a recess such that the circuit board is disposed within the recess, and when the light guide is coupled to the circuit breaker, a surface of the circuit breaker presses on the gasket to close the recess.
